(19) United States
(12) Patent Application Publication
(10) Pub. No.: US 2014/0380169 A1
(43) Pub. Date: Dec. 25, 2014

(54) LANGUAGE INPUT METHOD EDITOR TO DISAMBIGUATE AMBIGUOUS PHRASES VIA DIACRITICIZATION

(71) Applicant: Google Inc., Mountain View, CA (US)

(72) Inventor: Mohamed S. Eldawy, Mountain View, CA (US)

(21) Appl. No.: 13/922,342

(22) Filed: Jun. 20, 2013

(51) Int. Cl. G06F 3/16

(52) U.S. Cl. CPC G06F 3/167
USPC 715/728

(57) ABSTRACT

Disclosed are methods for disambiguating an input phrase or group of words. An implementation may include receiving a phrase as an input to a processor. The received phrase may be presented on a display device. The received phrase may be determined to be ambiguous based on a threshold uncertainty in either a definition or a pronunciation related to the phrase. An indication may be provided that a word in the phrase is the cause of the ambiguity. A menu of words with each word incorporating at least one diacritic mark to a word in the received phrase to disambiguate the received phrase may be presented. A word from the menu of words may be selected and presented on the display device.

### BACKGROUND

There are languages that allow phrases to be written with the short vowel sounds removed and replaced with diacritic marks to alert the user of a proper pronunciation or definition. However, often times because an author is familiar with the subject matter of the material that they are writing, the author may not enter the diacritic marks to a word that may be ambiguous in view of the context of the surrounding text. As a result, a reader may not completely understand the written material.

### BRIEF SUMMARY

According to an implementation of the disclosed subject matter, a method may include receiving a phrase as an input to a processor. The phrase may include a group of symbols representing words. The received phrase may be presented on a display device. The received phrase may be determined to be ambiguous based on a presence or absence of diacritic marks in individual symbols in the received phrase. An indication may be presented that the phrase is ambiguous. A menu of phrases that incorporate at least one diacritic mark to at least one word in the received phrase to disambiguate the received phrase may be presented.

According to an implementation of the disclosed subject matter, a method may include determining, by a processor, that a textual input received from an input device is ambiguous. The textual input may include at least one word. A repository of unambiguous words containing words similar to the received textual input may be assessed. The unambiguous words may include at least one diacritic mark that eliminates the ambiguity associated with the received textual input. Words from the repository that eliminate the ambiguity associated with the received textual input may be selected. Each of the selected words may correspond to a respective word in the received textual input. A menu containing the selected respective word for the corresponding words in the received textual input may be populated. The menu containing the unambiguous word may be associated with the corresponding ambiguous word in the textual input.

Advantageously, the presently disclosed subject matter may provide more concise content that is more easily understood by a reader. This provides the benefit of an improved user experience when viewing the content. Additionally, the various described training methods may allow for increased user input and influence over proper grammatical form and pronunciation of the respective languages.

Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a flowchart of a process according to an implementation of the disclosed subject matter.

FIG. 2 shows a flowchart of a process according to an implementation of the disclosed subject matter.

FIG. 3A shows an example of presentation of an input according to an implementation of the disclosed subject matter.

FIG. 3B shows an example presentation of an input according to an implementation of the disclosed subject matter.

FIG. 3C shows an example presentation of an input according to an implementation of the disclosed subject matter.

FIG. 3D shows an example presentation of an input according to an implementation of the disclosed subject matter.

FIG. 4 shows a network configuration according to an implementation of the disclosed subject matter.

FIG. 5 shows a computer according to an implementation of the disclosed subject matter.

### DETAILED DESCRIPTION

Disclosed is an input method editor (IME) that may automatically detect ambiguous phrases in a textual message (for example, a web site dialog, e-mail editor, word processing application, a blog editor or the like), highlight the ambiguous phrase in the editor presentation, and present options to disambiguate the ambiguous phrase.

Diacritization is the insertion of markings to a letter in a word to signal to a reader the sound that the letter is to make when pronounced. In some languages, the pronunciation may also affect the meaning of the word or phrase that includes the word. Languages particularly susceptible to the generation of ambiguous phrases without diacritization include Arabic, Aramaic, Farsi and Hebrew (although the scope of the present disclosure is not limited to any specific language or script). These languages include phrases that can be written with the short vowel sounds removed and replaced with diacritic marks to alert the user of a proper pronunciation or definition. As used herein, a phrase may be a word or a plurality of words. For example, in Arabic

[symbol]

could mean both “carrots” and “islands”, but the meaning is usually clear from the context. For example, a discussion of a garden would tend to imply the “carrots” usage, so no diacritic marks may be needed. However, the Arabic phrase [symbol]
could mean: “I drank”, “She drank” or “It was drunk.” A review of the sentence or passage context may be needed to understand which meaning the writer intended, or in some cases it may not be completely possible to determine a specific intended meaning, so diacritics are helpful to make the sentence more precise. For example, if the writer intended the meaning to be “I drank” the writer may write [symbol]
or if the writer meant “She drank” may write [symbol]
or, if the writer intended “It was drunk” may write [symbol]
using the appropriate diacritic marks. These different words may be selected based on the determined intended meaning of the sentence.

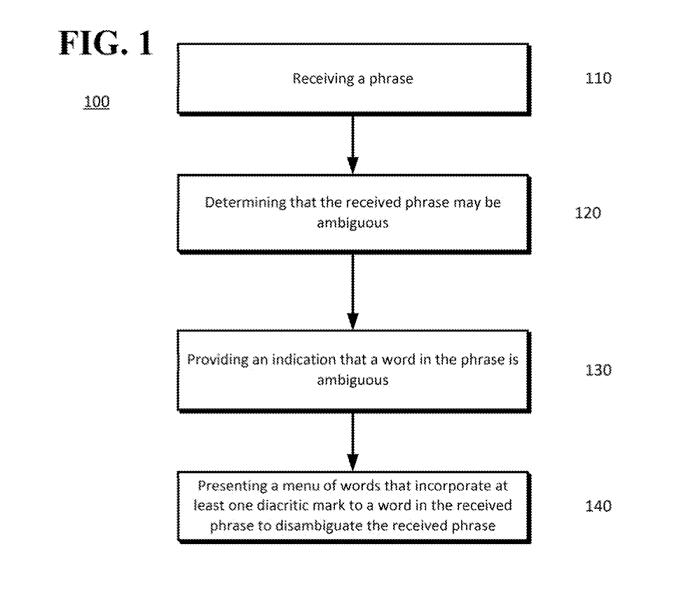

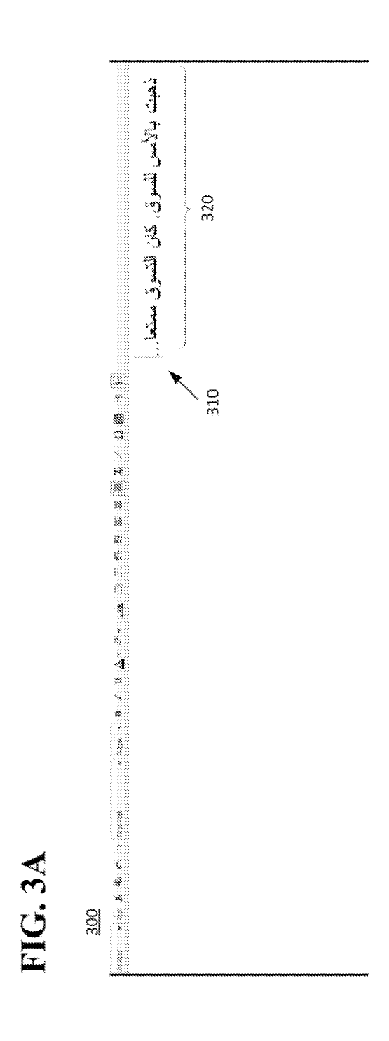

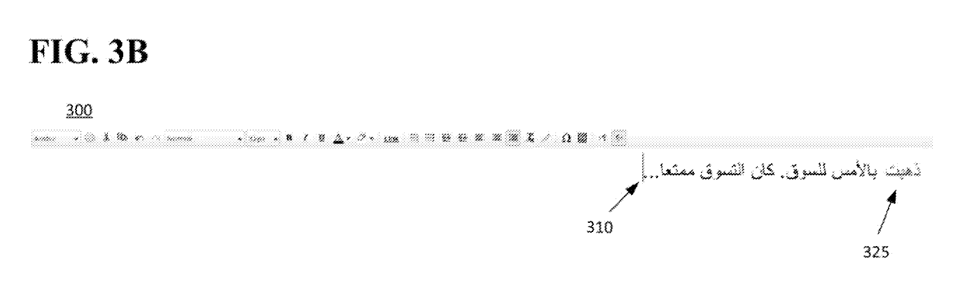

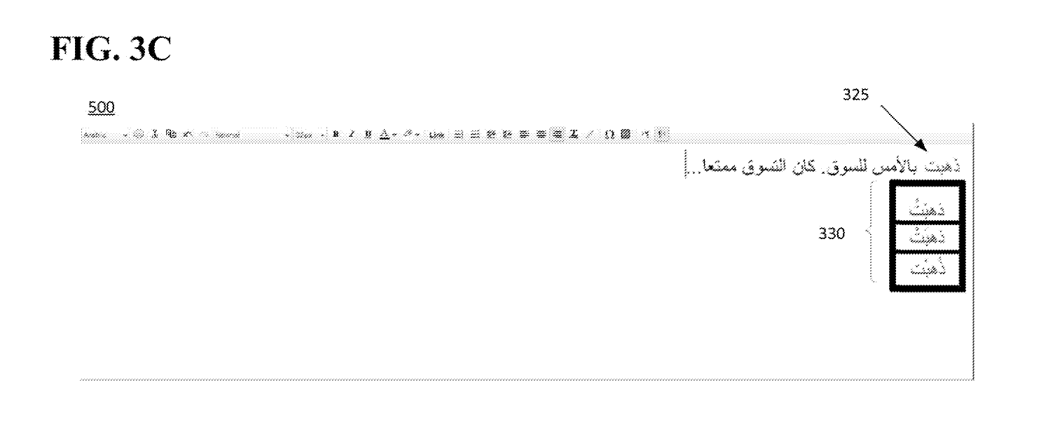

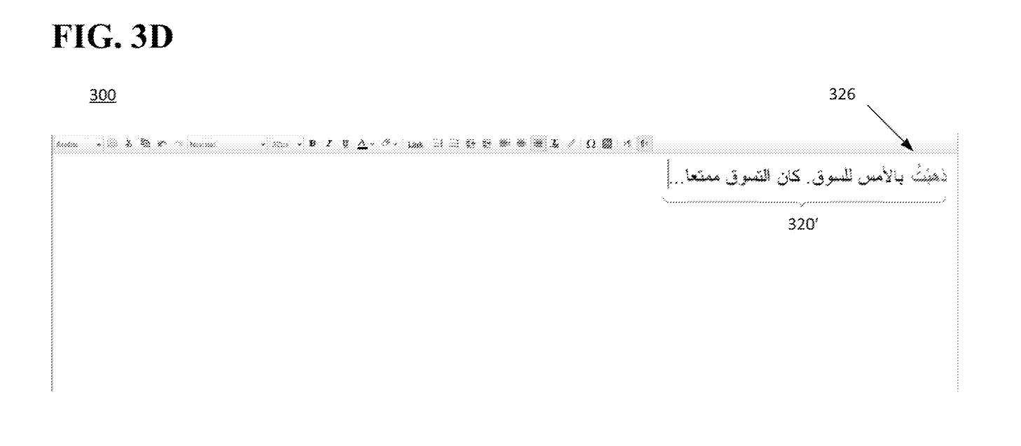

FIG. 1 shows a flowchart of a process according to an implementation of the disclosed subject matter. The process 100 may present an approach to alert a writer that a phrase in a sentence may be ambiguous to a reader. For example, a system may analyze inputted text to determine whether any phrases are ambiguous. The inputted text may be parsed to identify phrases and compare the phrases to a dictionary of phrases (obtained, for example, through training) In more detail, a phrase may be received as an input by a processor (110), and the phrase may include a group of symbols representing words. A symbol may be a word, letter or character. The received phrase may be in any language. For example, the phrase may be in a language selected from a group of languages consisting of Arabic, Aramaic, Farsi and Hebrew. Alternatively, the phrases may be symbols such as characters used in languages, such as Chinese, Korean, Japanese, and the like. The received phrase may be presented on a display device. With reference to FIG. 3A, the presentation 300 may include, for example, a cursor 310 and the received phrase 320, which, in this example, is an Arabic phrase. A processor may determine that the received phrase is ambiguous (120). The determination of ambiguity may be based, for example, on a threshold uncertainty in either a definition or a pronunciation related to the phrase or on the presence or absence of diacritic marks in the individual symbols in the received phrase. For example, a determination that a received phrase is ambiguous may be made by comparing the received phrase to a plurality of unambiguous phrases. In which case, the threshold uncertainty may be a binary unambiguous or ambiguous threshold. These phrases may be previously determined to be disambiguated and may be stored in a database. A result of the comparison may be a match between at least one of the plurality of unambiguous phrases and the received phrase. In response to the comparison result, words in the matching phrase may be selected that are different from words in the received phrase. In some implementations, a numerical threshold uncertainty value may be determined for a particular based on certain weightings assigned based on particular words used in the phrase or a word order of the phrase. For example, a probability of uncertainty, such as 50%-70% may be used as a minimum threshold uncertainty value for determining that an input is ambiguous, or the meaning is uncertain.

An indication that a word in the phrase is ambiguous may be provided on the display device (130). The ambiguous word may be highlighted, for example, by changing the color of the text, the color of the background, bolding the text, changing the font, or some other indication that the word may be ambiguous. See, for example, element 325 in FIG. 3B. A menu of words that incorporate at least one diacritic mark to a word in the received phrase to disambiguate the received phrase may be presented on the display device (140). A menu may be generated for each word that contributes, or, in other words, causes or leads to the ambiguity in the ambiguous phrase. For example, the menu may be populated for each of the respective selected words from the matching phrase. The menu of words may be a single word with a diacritic mark. A menu may be presented in response to an input associated with the indicated ambiguous word; for example, when a user places an input device, such as a mouse, a finger, stylus or the like, near or over the indicated ambiguous word, as shown in FIG. 3C, a menu 330 may be presented.

An example of how a received phrase may be determined to be ambiguous may be by comparing the received phrase to a plurality of unambiguous phrases. In response to a comparison result that provides a match from the plurality of phrases to the received phrase, words in the matching phrase that are different from words in the received phrase may be selected. A menu for each of the respective selected words from the matching phrase may be populated, and may be presented on a display device adjacent to the ambiguous word.

Another example of how a received phrase may be determined to be ambiguous may be based on the context of the phrase. The phrase context may be determined based on for example, a definition of the subject word in the received phrase. The determined context of the received phrase may be compared to a context list. One or more matching contexts from the context list may be selected. Context lists are discussed in more detail below. A list of known unambiguous phrases associated with the matching contexts may be retrieved from the matching context list stored in data storage. A menu may be populated with words from the list of unambiguous phrases.

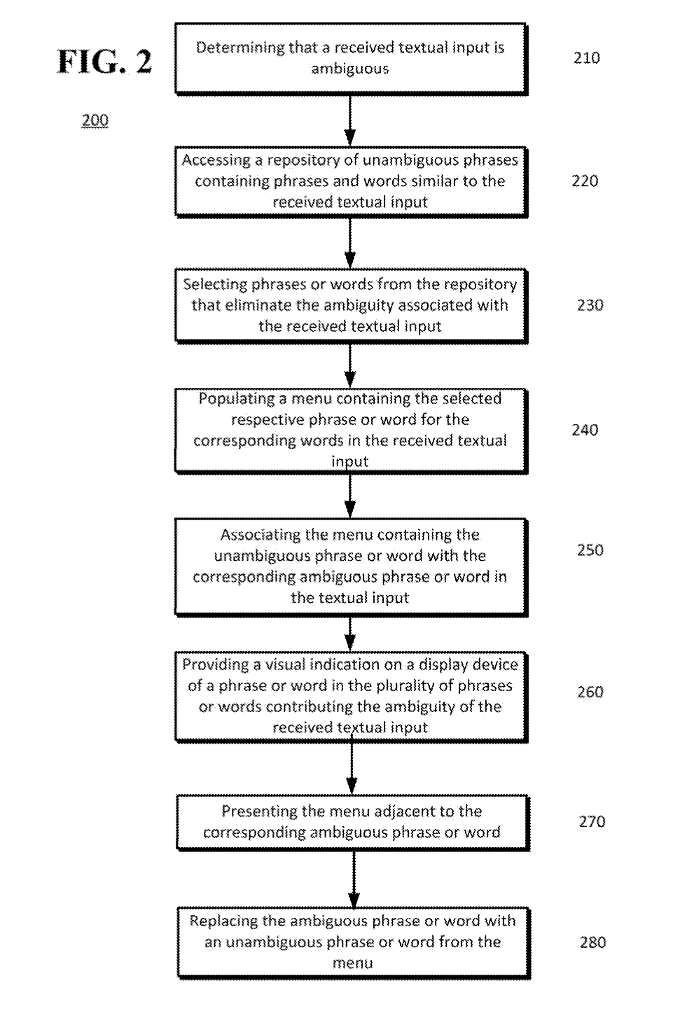

FIG. 2 shows a flowchart of a process according to an implementation of the disclosed subject matter. A process 200 may respond to a textual input received from an input device, or from another source, such as another remote device, user device, server or other device that may transmit text. The textual input may, for example, include at least one word. With reference to FIG. 3A, the presentation 300 may include, for example, a cursor 310 and the received phrase 320, which is an Arabic phrase. In response to the received textual input, a processor may determine that the received textual input may be ambiguous (210). A repository of unambiguous phrases containing words similar to the received textual input may be accessed (220). The phrases or words from the repository that eliminate the ambiguity associated with the received textual input may be selected (230). Each of the selected words or phrase may correspond to a respective word or phrase in the received textual input, and may include at least one diacritic mark that eliminates the ambiguity associated with the received textual input. A menu containing the respective selected unambiguous word or phrase for the corresponding words in the received textual input may be populated (240). The menu containing the unambiguous word or phrase may be associated with the corresponding ambiguous word in the textual input (250). In response to the determination that the received textual input is ambiguous, a visual indication may be provided on a display device of a word in the plurality of words or phrase contributing the ambiguity of the received textual input (260). With reference to FIG. 3B, the presentation 300 may include, for example, a cursor 310 and the visual indication of the word 325 contributing to the ambiguity. The word 325 may be a phrase that may contain one or more words. A menu may be presented adjacent to the corresponding ambiguous word. For example, a menu 330 as shown in FIG. 3C may be presented below the ambiguous word. Of course, the menu 330 may alternatively be presented above or beside the ambiguous word. In response to a selection of a word or phrase presented in the menu, the ambiguous word or phrase may be replaced with an unambiguous word from the presented menu (280). The replaced word 326 may be shown in a disambiguated received textual input 320′.

In an example, a received textual input may be determined to be ambiguous by comparing a respective word or phrase in the received textual input to a list of unambiguous words or phrases. The respective word in the received textual input may be determined to be ambiguous, if none of the unambiguous words are an exact match to the respective word. Individual unambiguous words from the list of unambiguous words that correspond to the respective word may be selected for populating a menu of words. Alternatively, unambiguous phrases from the list of unambiguous phrases that correspond to the respective phrase may be selected for populating a menu of phrases. Unambiguous words may be considered to correspond to the respective ambiguous word, if the unambiguous word has a substantially similar letter or symbol order as the respective ambiguous word. For example, 5 of 8 of the letters are in the same order in the words under consideration. Alternatively, an ambiguous phrase may have a similar number of words as an unambiguous phrase, and individual words or symbols in the respective phrase may be analyzed based on the presence or absence of diacritic marks.

In another alternative, data storage may contain a set of context categories, such as sports, movies, feminine, masculine, asexual, dance, music, literature, electronics, business, personal matters, formal matters, and the like. A context of the received textual input may be identified. For example, the context of the received textual input may be determined based on a historical use of the received textual input by a user. Alternatively, the context of the received textual input may be determined using on a contributor database. A contributor may be an arbitrary, random user that provides examples of ambiguous textual inputs. The contributor data base may contain a contextual explanation of the received textual input.

Using the identified context, a list of context-related symbols, words or phrases may be retrieved from data storage. A symbol, word or phrase in the received textual input may be compared to words in the list of context-related words. A symbol, word or phrase in the received textual input may be identified as ambiguous in response to the comparison failing to find a matching symbol, word or phrase in the list of the context-related symbols, words or phrases. A match may relate to letters and/or diacritic marks in the compared symbols, words or phrases.

Once a phrase is determined to be ambiguous, the editor may highlight the ambiguous phrase to alert the user of the potentially ambiguous phrase. The alert may take the form of highlighting the text using either a different text color, a different font, surrounding the word with some sort of box or the like. For example, when a phrase is detected as ambiguous, the ambiguous phrase may be highlighted, and a menu of the options the system determines should replace the inputted phrase may be presented. The options may be a list of diacritized phrases that are determined to be likely appropriate for the context and to be unambiguous. A user may select the appropriate diacritization to disambiguate the phrase.

The list of options may be refined based on the context of the previously entered text or subject matter, and may be adjusted based on user interaction with the menu. For example, the system may dynamically adjust the number of suggestions based on the user's usage of the drop down windows. The options presented may change as some pronunciations or phrases become obsolete. Alternatively, the system may highlight ambiguous text, but also allow a user to manually enter the appropriate diacritization to disambiguate the phrase.

Training of the context dictionaries, ambiguous phrases, unambiguous phrases and the like may be performed according to a number of techniques. A dictionary may be generated, for example, by training a recognizer that may analyze usage of the phrases by other writers, such as usage in web sites, blogs, comments, ratings, electronically published documents and other publically available sources, using inputs to a game generated for the purpose of obtaining ambiguous terms, log-in dialogs that accept ambiguous phrases. For example, a web site or document may be scanned to determine if the phrase is used with diacritic marks. The system may determine that phrases with which diacritic marks are more frequently used may indicate that the phrase without the diacritic marks may be ambiguous. For example, if through training, a phrase is found to have diacritic marks approximately 70% of the time and the same phrase is input by a user of the IME without any diacritic marks, the system may indicate that the user's phrase may be ambiguous. In other words, it may be inferred that more frequently diacritized words are more often considered ambiguous without the diacritic marks.

Alternatively, the system may determine a phrase's ambiguity based on the context in which the phrase is used, and a list of context-related words may be retrieved from data storage. For example, a system may analyze the phrase and the context in which it is being used. The system may compare the context and the phrase to determine how many different diacritizations have been noted for the particular phrase in this specific context. The system may only count those instances in which diacritics were noted for the phrase.

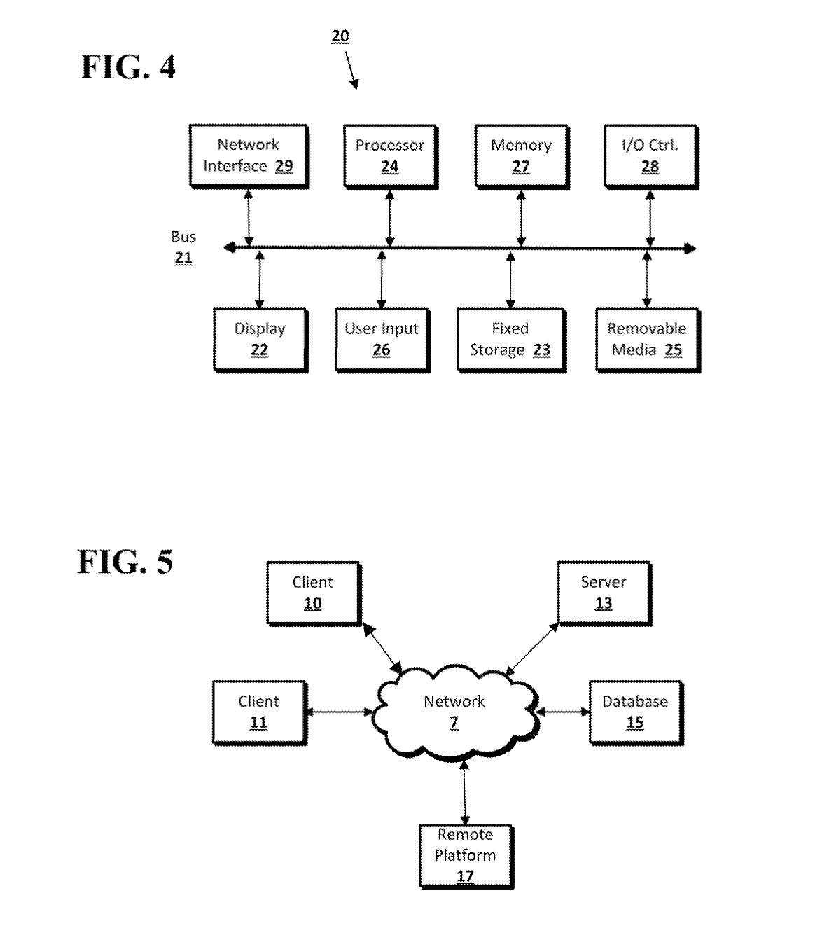

Embodiments of the presently disclosed subject matter may be implemented in and used with a variety of component and network architectures. FIG. 4 is an example computer 20 suitable for implementing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM nor flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 8.

Many other devices or components (not shown) may be connected in a similar manner (e.g., document scanners, digital cameras and so on). Conversely, all of the components shown in FIG. 4 need not be present to practice the present disclosure. The components can be interconnected in different ways from that shown. The operation of a computer such as that shown in FIG. 4 is readily known in the art and is not discussed in detail in this application. Code to implement the present disclosure can be stored in computer-readable storage media such as one or more of the memory 27, fixed storage 23, removable media 25, or on a remote storage location.

FIG. 5 shows an example network arrangement according to an implementation of the disclosed subject matter. One or more clients 10, 11, such as local computers, smart phones, tablet computing devices, and the like may connect to other devices via one or more networks 7. The presentation 300 of FIGS. 3A-3D may be presented on display devices connected to a client, such as clients 10, 11. The network may be a local network, wide-area network, the Internet, or any other suitable communication network or networks, and may be implemented on any suitable platform including wired and/or wireless networks. The clients may communicate with one or more servers 13 and/or databases 15. The context libraries and lists of ambiguous/unambiguous words or phrases may be stored in a local storage, such as the memory 27, fixed storage 23, removable media 25, or on databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving a phrase, wherein the phrase includes a group of symbols representing at least one word;
presenting the received phrase on a display device;
determining that the received phrase is ambiguous based on a presence or absence of a diacritic mark in at least one symbol in the received phrase;
presenting an indication that the received phrase is ambiguous; and
presenting a menu of phrases that incorporate at least one diacritic mark to at least one word in the received phrase to disambiguate the received phrase.

2. The method of claim 1, wherein determining that a received phrase is ambiguous, comprises:
comparing the received phrase to a plurality of unambiguous phrases;
in response to a comparison result that provides a match from the plurality of unambiguous phrases to the received phrase, selecting words in the matching phrase that have diacritic marks different from words in the received phrase; and
populating a menu for each of the respective selected words from the matching phrase.

3. The method of claim 1, wherein determining that a received phrase is ambiguous, comprises:
determining a context of the received phrase;
using the determined context of the received phrase to retrieve a list of unambiguous phrases;
populating a menu with phrases from the list of unambiguous phrases; and
presenting the menu on the display device.

4. The method of claim 3, further comprising:
comparing the determined context of the received phrase to a context list;
selecting a matching context from the context list based on a match to the determined context of the received phrase; and
retrieving a list of unambiguous phrases from the matching context list.

5. The method of claim 1, further comprising:
identifying a word in the ambiguous phrase that causes the phrase to be ambiguous.

6. The method of claim 1, further comprising:
generating a menu for each word that causes the ambiguity in the ambiguous phrase.

7. The method of claim 1, wherein the menu of phrase may be a single word with a diacritic mark.

8. The method of claim 1, wherein the indication is a highlighting of an ambiguous word in the phrase.

9. The method of claim 1, wherein the menu of phrases is presented in response to an input associated with the indicated ambiguous word.

10. The method of claim 1, wherein the received phrase is in a language selected from a group of languages consisting of Arabic, Aramaic, Farsi and Hebrew.

11. The method of claim 1, further comprising:
in response to an input, replacing an ambiguous word in the phrase with a word presented in the menu of phrases.

12. The method of claim 1, wherein the phrase is received as an input from a user.

13. A method, comprising:
determining, by a processor, that a textual input received from an input device is ambiguous, wherein the textual input includes at least one word;
accessing a repository of unambiguous words containing words similar to the received textual input, wherein the unambiguous words include at least one diacritic mark that eliminates the ambiguity associated with the received textual input;
selecting words from the repository that eliminate the ambiguity associated with the received textual input, each of the selected words corresponding to a respective word in the received textual input;
populating a menu containing the selected respective word for the corresponding words in the received textual input; and
associating the menu containing the unambiguous word with the corresponding ambiguous word in the textual input.

14. The method of claim 13, wherein determining that the received textual input is ambiguous, comprises:
comparing a respective word of the plurality of words in the received textual input to a list of unambiguous words retrieved from the repository of unambiguous words;
determining that none of the unambiguous words are an exact match to the respective word; and
selecting individual unambiguous words from the list of unambiguous words that correspond to the respective word.

15. The method of claim 13, further comprising:
presenting the received textual input on a display device.

16. The method of claim 13, further comprising:
in response to the determination that the received textual input is ambiguous, providing a visual indication on a display device of a word in the plurality of words contributing the ambiguity of the received textual input.

17. The method of claim 13, wherein determining the textual input is ambiguous comprises:
identifying a context of the received textual input;
retrieving a list of context-related words from a data storage;
comparing a word in the received textual input to words in the list of context-related words;
identifying a word in the received textual input as ambiguous in response to the comparison failing to find a matching word in the list of the context-related words, wherein a match relates to letters and diacritic marks in compared words.

18. The method of claim 17, wherein context of the received textual input is determined based on a historical use of the received textual input by a user.

19. The method of claim 17, wherein context of the received textual input is determined based on a contributor database containing a contextual explanation of the received textual input, wherein a contributor is a random user that provides examples of ambiguous textual inputs.

20. The method of claim 13, further comprising:
in response to a selection, replacing an ambiguous word with a selected respective word presented in the menu of words.
